(19) United States
(12) Patent Application Publication
(10) Pub. No.: US 2007/0078731 A1
(43) Pub. Date: Apr. 5, 2007

(54) System and method for auto-configuration based on a pre-paid subscription

(75) Inventors: Tapio Hameen-Anttila, Helsinki (FI); Ahti Muhonen, Hirvihaara (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/210,366

(22) Filed: Aug. 24, 2005

(51) Int. Cl. G06Q 30/00

(52) U.S. Cl. 705/27

(57) ABSTRACT

A method, server, system and computer program product for providing one or more content files to a user terminal are provided, wherein the credit balance of a user associated with the user terminal is consulted prior to commencing the transmission of the content files. Where it is determined that the user's credit balance is insufficient to cover the content file requested, at least part of the content file may be modified so as to reduce its size prior to transmission. If it is determined that the content file cannot be sufficiently modified to compensate for the user's credit deficit, a message may be sent notifying the user that he or she does not have sufficient credit for the content file requested. The content file may further be partitioned either prior to or after modification, and one or more content selection points may be inserted into various content parts enabling the user to designate, prior to receiving the entire content file, whether or not he or she wishes to continue receiving parts of the content file. A user terminal capable of receiving one or more content files including the content selection points is also provided.

### FIELD OF THE INVENTION

Embodiments of this invention relate to mobile services, and more particularly to the downloading of content files to a mobile device.

### BACKGROUND OF THE INVENTION

In the past consumer markets have concentrated on mobile services which utilize only small sized files. For example, mobile consumers have generally focused their energy on downloading ring tones, background images, screen savers and/or Java games, which occupy only small sized files, to their mobile devices. Current trends, however, are making the use of multimedia services increasingly popular in wired and wireless domains, and are, therefore, driving the need for large file downloading capabilities. In response, the capabilities of mobile phones have been developed rapidly in order to answer the needs of demanding consumers. For example, mobile devices have been equipped with high quality colored displays, processors with increased powers, and memory having an increased storage capacity. Today's applications together with consumer's consumption habits have caused remarkable growth in the number and size of transferred files in communications networks.

The Nokia Media Charger is one example of a client-server solution that enables a mobile device user to receive these large content files, such as videos, music and TV programs, for off-line consumption. Using the Media Charger, a user can select the multimedia content file he or she would like to receive, and the content files can then be delivered to the user's mobile device, for example, overnight (i.e., off-peak times) over existing cellular networks (e.g., General Packet Radio Service (GPRS), Enhanced Data for GSM (Global System for Mobile Communications) Evolution (EDGE) or Wideband Code Division Multiple Access (WCDMA)). The content is then stored in the device memory (e.g., on the device's multimedia memory card (MMC)) for later consumption.

Examples of multimedia content that can be transmitted to a user's mobile device may include: cartoons, short films, documentaries, music videos, concert footage, weekly video charts, songs and even complete albums. One exemplary use of the Media Charger is the TV Episode Service. Using this service a mobile device user can subscribe to a particular television station and show in order to have every episode of that show automatically delivered to the user's mobile device. For example, the show may be delivered daily (or weekly) to the user's mobile device overnight the evening before the same show is aired on television.

There are many different ways that a user can be billed for the content files he or she receives. For example, the user may have an endless subscription that remains valid until the user cancels it, wherein the user is billed for the same amount on a regular basis (e.g., monthly). Alternatively, the user may be billed each time he or she receives a new content file.

In some instances the user may use a Pre-Paid System for receiving content files from a content server. Under a Pre-Paid System a user may pay upfront for a certain number of content files of the same size (e.g., 10 episodes of the same show). Alternatively, the user may purchase a certain amount of content, for example, a certain number of Megabytes of data. This enables the user to receive different types of content files (e.g., TV episodes, music files, etc.), rather than being limited to a certain number of the same type of content file. Under this system, once the user has paid, he or she will have an available credit balance for any future content files he or she wishes to receive. The user's account information (which is accessible by, for example, a Media Charger Server and/or a separate Billing System) will include the user's available credit balance. Each time the user receives a content file his or her credit will be debited, until the user no longer has any available credit.

A problem may arise, however, where a user has some available credit, but it is not enough for a particular content file he or she would like to have transmitted to his or her mobile device. For example, where a particular music video is 10 Megabytes of data, but the user only has enough available credit for 8 Megabytes. Currently what happens is that the user will begin receiving the content file, and if the user runs out of available credit in the middle of downloading the multimedia content, the user will receive a message stating that his or her credit has run out and that the downloaded content (i.e., the portion of the content file that has been downloaded up to that point) will be deleted from the mobile device, since the download was not complete. The ultimate result is that user has used up all of his or her credit, yet has nothing to show for it, since the content file selected for download was never completely downloaded.

### BRIEF SUMMARY OF THE INVENTION

Generally described, various exemplary embodiments of the present invention provide a solution to at least the problem discussed above by providing a method, system, server and computer program product for providing one or more content files to a mobile terminal, wherein the credit balance of a user associated with the mobile terminal is consulted prior to commencing the transmission of the content files. Where it is determined that the user's credit balance is insufficient to cover the content file requested, at least part of the content file may be modified so as to downscale it, or reduce its size, prior to transmission. If it is determined that the content file cannot be sufficiently modified to compensate for the user's credit deficit, a message may be sent notifying the user that he or she does not have sufficient credit for the content file requested. The content file may further be partitioned either prior to or after modification. In one exemplary embodiment, content selection points may further be inserted into one or more of the partitioned content parts. These content selection points enable the user to view, listen to, or otherwise check, a portion of the content file before committing to download (or otherwise consume), and, therefore, pay for, the entire content file. A mobile terminal capable of receiving one or more content files including these content selection points and of presenting these content selection points to the user for selection is also provided.

According to one exemplary aspect of the present invention a method of providing one or more content files to a user terminal is provided. In one exemplary embodiment, the method includes: (1) receiving a request for a content file from a user associated with the user terminal; (2) determining whether a credit balance associated with the user is sufficient for the content file requested; (3) modifying at least part of the content file where it is determined that the credit balance is not sufficient; and (4) transmitting at least part of the content file to the user terminal.

In exemplary embodiments the method may further include, upon a determination that the credit balance is insufficient, determining whether the content file can be sufficiently modified so that the size of the modified content file is equal to or less than the size of the credit balance and, where it is determined that the content file cannot be sufficiently modified, transmitting a message to the user indicating that the user has an insufficient credit balance for the content file requested.

In one exemplary embodiment the method may further include partitioning the content file into a plurality of content parts. Exemplary embodiments may further include inserting a content selection point into at least one group of content parts prior to transmission of the group of content parts, wherein the content selection point allows the user to specify whether he or she wishes to receive one or more additional groups of content parts.

According to another aspect of the present invention, a server capable of providing one or more content files to a user terminal is provided. In one exemplary embodiment the server comprises a processor and a memory module in communication with the processor. The memory module may store an application that is executable by the processor and is capable, upon execution, of receiving a request for a content file from a user associated with the user terminal, determining whether a credit balance associated with the user is sufficient for the content file requested, modifying at least part of the content file where it is determined that the credit balance is not sufficient, and transmitting at least part of the content file to the user terminal.

According to yet another aspect of the present invention, a system for providing a mobile terminal with one or more content files is provided. In one exemplary embodiment, the system may include a user terminal and a server, wherein the user terminal is capable of transmitting a request by a user for a content file, and the server is in communication with the user terminal for receiving the request. The server may be capable of determining whether a credit balance associated with the user is sufficient for the content file requested, modifying at least part of the content file where it is determined that the credit balance is not sufficient, and transmitting at least part of the content file to the user terminal.

According to another aspect of the present invention, a computer program product for providing a content file to a user terminal is provided. In one exemplary embodiment, the computer program product includes at least one computer-readable storage medium having computer-readable program code portions stored therein. These computer-readable program code portions may include: (1) a first executable portion for receiving a request for a content file from a user associated with the user terminal; (2) a second executable portion for determining whether a credit balance associated with the user is sufficient for the content file requested; (3) a third executable portion for modifying at least part of the content file where it is determined that the credit balance is not sufficient; and (4) a fourth executable portion for transmitting at least part of the content file to the user terminal. According to yet another aspect of the present invention a user terminal capable of receiving one or more content files is provided. In one exemplary embodiment the user terminal includes means for: (1) transmitting a request for a content file comprising one or more parts; (2) receiving, in response to the request, at least one part of the content file requested, said part including a content selection point enabling a user associated with the user terminal to specify whether the user wishes to receive one or more additional parts of the content file requested; (3) presenting the content selection point to the user and enabling the user to specify whether the user wishes to receive one or more additional parts; and (4) transmitting a request for one or more additional parts of the content file requested in response to the user specifying that the user wishes to receive one or more additional parts. The user terminal may further include means for storing the one or more content parts of the content file received.

### BRIEF DESCRIPTION OF THE DRAWING

Having thus described the invention in general terms, reference will now be made to the accompanying drawings, which are not necessarily drawn to scale, and wherein:

FIG. 1 is a block diagram of one type of system that would benefit from exemplary embodiments of the present invention;

FIG. 2 is a schematic block diagram of an entity capable of operating as a mobile station, a content provider server, a billing system, and/or a media charger server in accordance with embodiments of the present invention.

FIG. 3 is a schematic block diagram of a mobile station capable of operating in accordance with an exemplary embodiment of the present invention;

FIGS. 4A-4G are flow charts illustrating a method of providing one or more content files to a mobile terminal in accordance with exemplary embodiments of the present invention; and

FIG. 5 is a block diagram illustrating the partitioning and selection of various parts of a content file in accordance with an exemplary embodiment of the present invention.

### DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

Overview:

Exemplary embodiments of the present invention provide a method, server, system and computer program product for providing one or more content files (e.g., cartoons, short films, documentaries, music videos, concert footage, audio files, video files, movies, games, etc.) to a mobile terminal, such as a cellular telephone, personal digital assistance (PDA), laptop computer, mobile communication device, audio/video player, digital camera, digital camcorder, portable TV, game device, or the like, wherein the user associated with the mobile terminal is using a Pre-Paid System to purchase the content files.

As stated above, a problem may arise where a user using a Pre-Paid System has some available credit, but it is not enough for a particular content file he or she would like to have transmitted to his or her mobile terminal. Currently what happens is that if the user runs out of available credit in the middle of downloading the multimedia content, the user will receive a message stating that his or her credit has run out and that the portion of the content downloaded thus far will be deleted from the mobile device, since the download was not complete. The ultimate result is that user has used up all of his or her credit, yet has nothing to show for it, since the content file selected for download was never completely downloaded.

Exemplary embodiments of the present invention solve at least this problem by providing a method of providing one or more content files to a mobile terminal wherein the method includes first checking to see whether or not the user has sufficient available credit to download the selected content file. Where the user does not have sufficient credit, the method further includes modifying all or part of the selected content file in order to downscale it, or reduce its size, thus reducing the credit required to purchase the particular content file requested by the user. Many methods can be used to reduce the size of the content file depending on the type of content and how drastic the downscaling needs to be. These methods are discussed in more detail below.

If the content file cannot be modified sufficiently to make up for the credit deficit (i.e., the amount of additional credit that is needed to download the content file requested), the user will be notified that he or she does not have sufficient credit and that the user should purchase more credit if he/she wishes to continue purchasing content files using the Pre-Paid System. This occurs before download commences, so that the user does not lose any of his or her then available credit.

In addition, exemplary embodiments of the present invention involve partitioning the content file into a plurality of content parts (for example, where the content file would naturally be split, e.g., between scenes in a movie, or arbitrarily at points selected by a service provider) either prior to or after at least part of the content file is modified. By partitioning the content file prior to modification, each content part may be modified differently. In other words, each content part can be downscaled or reduced in size to a varying degree.

In other exemplary embodiments, content selection points may be inserted into the various content parts. The selection points can then be presented to the user in order to allow the user to select between downloading further content and stopping the downloading of the content. This enables the user to review a portion of the content file and then determine whether or not he or she wishes to continue receiving the content file (thereby using up his or her available credit), rather than having to wait until the entire content is downloaded or transmitted before making that determination. By allowing the user to stop purchasing, for example a movie that he or she is not enjoying, this enables the user to conserve his or her available credit, rather than waste it on something the user does not want.

Overall System and Mobile Station:

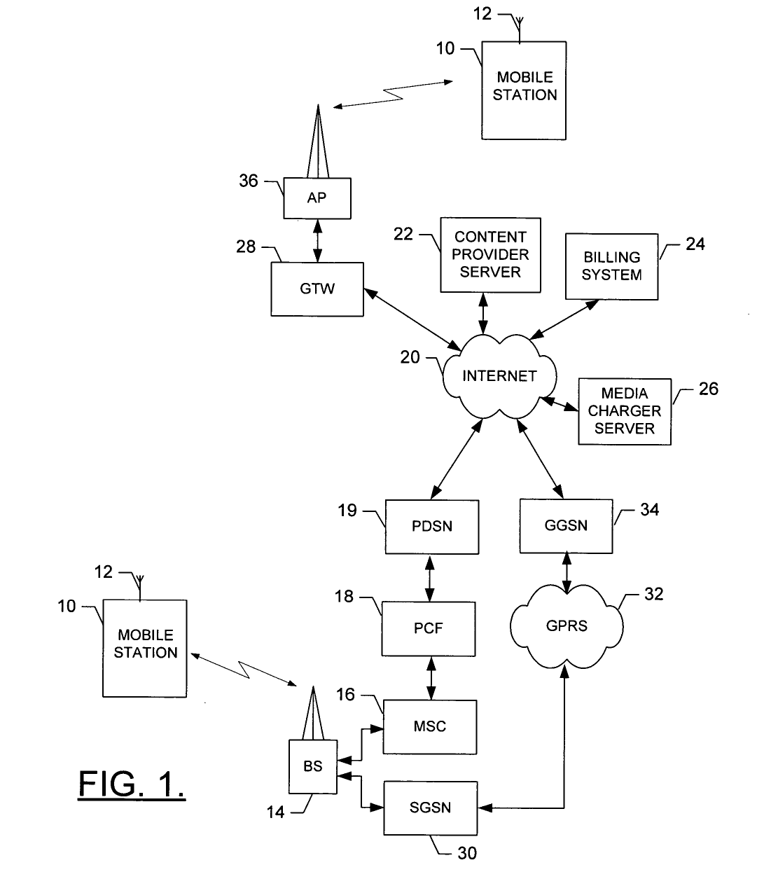

Referring to FIG. 1, an illustration of one type of system that would benefit from the present invention is provided. The system, method, server, mobile terminal and computer program product of embodiments of the present invention will be primarily described in conjunction with mobile communications applications. It should be understood, however, that the system, method, server, mobile terminal and computer program product of embodiments of the present invention can be utilized in conjunction with a variety of other applications, both in the mobile communications industries and outside of the mobile communications industries. For example, the system, method, server, mobile terminal and computer program product of embodiments of the present invention can be utilized in conjunction with wireline and/or wireless network (e.g., Internet) applications.

As shown in FIG. 1, the system can include one or more mobile stations 10, each having an antenna 12 for transmitting signals to and for receiving signals from one or more base stations (BS's) 14. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Packet Control Function (PCF) 18, and the PCF is coupled to a Packet Data Serving Node (PDSN) 19, which is in turn coupled to a WAN, such as the Internet 20. In turn, devices such as processing elements (e.g., personal computers, server computers or the like) can be coupled to the mobile station 10 via the Internet. For example, the processing elements can include a content provider server 22, a billing system 24 and/or a media charger server 26, discussed below. As will be appreciated, the processing elements can comprise any of a number of processing devices, systems or the like capable of operating in accordance with embodiments of the present invention.

The BS 14 can also be coupled to a signaling GPRS (General Packet Radio Service) support node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 16, the AP's can be directly coupled to the Internet. In one embodiment, however, the APs are indirectly coupled to the Internet via a GTW 28. As will be appreciated, by directly or indirectly connecting the mobile stations and the processing elements (e.g., content provider server 22, billing system 24, and/or media charger server 26) and/or any of a number of other devices to the Internet, whether via the AP's or the mobile network(s), the mobile stations and processing elements can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to one or more processing elements (e.g., a content provider server 22, a billing system 24, and/or a media charger server 26) across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques. Further, the mobile station 10 and the processing elements can be coupled to one or more electronic devices, such as printers, digital projectors and/or other multimedia capturing, producing and/or storing devices (e.g., other terminals).

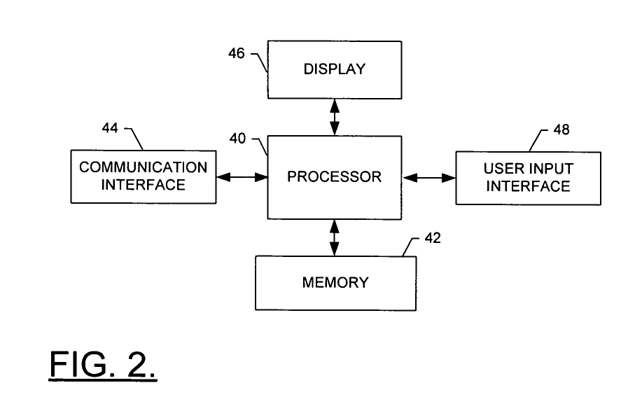

Referring now to FIG. 2, a block diagram of an entity capable of operating as a mobile station 10, content provider server 22, billing system 24 and/or media charger server 26 is shown in accordance with one embodiment of the present invention. The entity capable of operating as a mobile station, content provider server, billing system and/or media charger server includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. As shown, the entity capable of operating as a mobile station 10, content provider server 22, billing system 24 and/or media charger server 26 can generally include means, such as a processor 40 connected to a memory 42, for performing or controlling the various functions of the entity. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

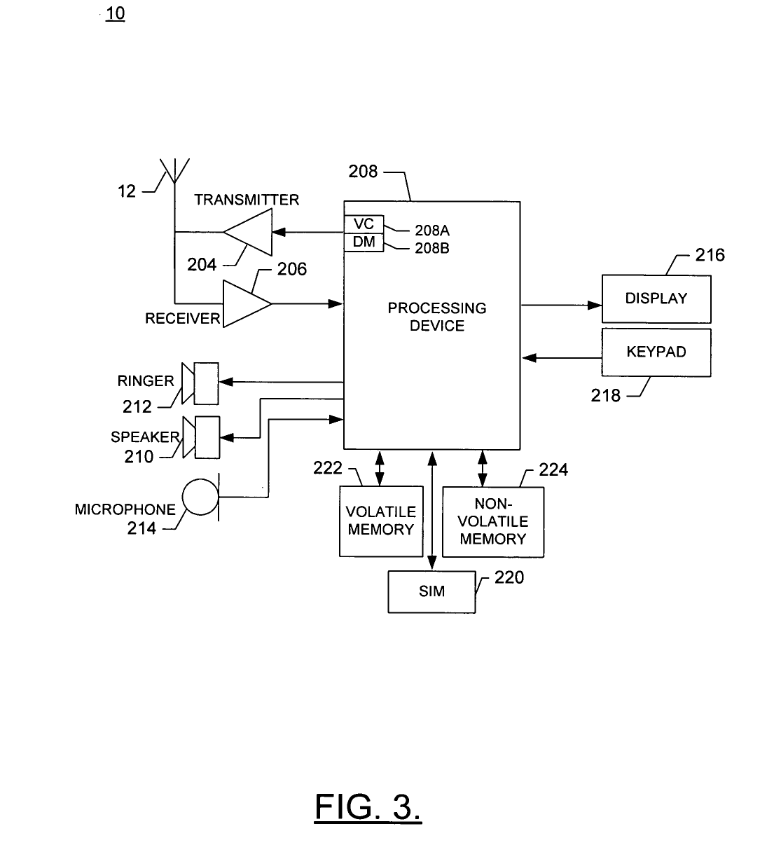

Reference is now made to FIG. 3, which illustrates one type of mobile station 10 that would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as personal digital assistants (PDAs), pagers, laptop computers and other types of electronic systems, can readily employ embodiments of the present invention. In general, the mobile station may be any device for receiving and presenting content, such as a TV, a set-top box (STB), a personal video recorder, a digital video recorder, a digital radio, a digital/audio device, an on-board computer, a GPS receiver, a wrist watch, etc., or any combination thereof.

The mobile station includes various means for performing one or more functions in accordance with exemplary embodiments of the present invention, including those more particularly shown and described herein. It should be understood, however, that one or more of the entities may include alternative means for performing one or more like functions, without departing from the spirit and scope of the present invention. More particularly, for example, as shown in FIG. 3, in addition to an antenna 12, the mobile station 10 includes a transmitter 204, a receiver 206, and means, such as a processing device 208, e.g., a processor, controller or the like, that provides signals to and receives signals from the transmitter 204 and receiver 206, respectively. These signals include signaling information in accordance with the air interface standard of the applicable cellular system and also user speech and/or user generated data. In this regard, the mobile station can be capable of operating with one or more air interface standards, communication protocols, modulation types, and access types. More particularly, the mobile station can be capable of operating in accordance with any of a number of second-generation (2G), 2.5G and/or third-generation (3G) communication protocols or the like. Further, for example, the mobile station can be capable of operating in accordance with any of a number of different wireless networking techniques, including Bluetooth, IEEE 802.11 WLAN (or Wi-Fi®), IEEE 802.16 WiMAX, ultra wideband (UWB), and the like.

It is understood that the processing device 208, such as a processor, controller or other computing device, includes the circuitry required for implementing the video, audio, and logic functions of the mobile station and is capable of executing application programs for implementing the functionality discussed herein. For example, the processing device may be comprised of various means including a digital signal processor device, a microprocessor device, and various analog to digital converters, digital to analog converters, and other support circuits. The control and signal processing functions of the mobile device are allocated between these devices according to their respective capabilities. The processing device 208 thus also includes the functionality to convolutionally encode and interleave message and data prior to modulation and transmission. The processing device can additionally include an internal voice coder (VC) 208A, and may include an internal data modem (DM) 208B. Further, the processing device 208 may include the functionality to operate one or more software applications, which may be stored in memory. For example, the controller may be capable of operating a connectivity program, such as a conventional Web browser. The connectivity program may then allow the mobile station to transmit and receive Web content, such as according to HTTP and/or the Wireless Application Protocol (WAP), for example.

The mobile station may also comprise means such as a user interface including, for example, a conventional earphone or speaker 210, a ringer 212, a microphone 214, a display 216, all of which are coupled to the controller 208. The user input interface, which allows the mobile device to receive data, can comprise any of a number of devices allowing the mobile device to receive data, such as a keypad 218, a touch display (not shown), a microphone 214, or other input device. In embodiments including a keypad, the keypad can include the conventional numeric (0-9) and related keys (#, *), and other keys used for operating the mobile station and may include a full set of alphanumeric keys or set of keys that may be activated to provide a full set of alphanumeric keys. Although not shown, the mobile station may include a battery, such as a vibrating battery pack, for powering the various circuits that are required to operate the mobile station, as well as optionally providing mechanical vibration as a detectable output.

The mobile station can also include means, such as memory including, for example, a subscriber identity module (SIM) 220, a removable user identity module (R-UIM) (not shown), or the like, which typically stores information elements related to a mobile subscriber. In addition to the SIM, the mobile device can include other memory. In this regard, the mobile station can include volatile memory 222, as well as other non-volatile memory 224, which can be embedded and/or may be removable. For example, the other non-volatile memory may be embedded or removable multimedia memory cards (MMCs), Memory Sticks as manufactured by Sony Corporation, EEPROM, flash memory, hard disk, or the like. The memory can store any of a number of pieces or amount of information and data used by the mobile device to implement the functions of the mobile station. For example, the memory can store an identifier, such as an international mobile equipment identification (IMEI) code, international mobile subscriber identification (IMSI) code, mobile device integrated services digital network (MSISDN) code, or the like, capable of uniquely identifying the mobile device. The memory can also store content. The memory may, for example, store computer program code for an application and other computer programs. For example, in one embodiment of the present invention, the memory may store computer program code for enabling the mobile station to receive at least part of a content file requested, wherein the part received includes a content selection point that enables the user of the mobile station to designate whether he or she wishes to receive additional parts of the content file. The computer program code may further enable the mobile station to present the received part and content selection point to the user and to request additional parts of the content file where the user indicates his or her desire to do so.

It should be understood that while the mobile station was illustrated and described as comprising a mobile telephone, mobile telephones are merely illustrative of one type of mobile station that would benefit from the present invention and, therefore, should not be taken to limit the scope of the present invention. While several embodiments of the mobile station are illustrated and described for purposes of example, other types of mobile stations, such as personal digital assistants (PDAs), pagers, laptop computers, tablets, and other types of electronic systems including both mobile, wireless devices and fixed, wireline devices, can readily employ embodiments of the present invention.

Modifying Content Files Based on User's Available Credit:

As discussed above, exemplary embodiments of the present invention provide a method, system, server and computer program product for providing one or more content files to a mobile terminal, wherein a credit balance of a user associated with the mobile terminal is checked before the transmission of the content file begins. By checking the user's credit balance before beginning transmission of the content file, one can avoid the situation where a user runs out of credit in the middle of downloading, or otherwise consuming, a requested content file and ends up using all of his or her available credit yet ultimately receiving nothing. According to exemplary embodiments, where the user does not have sufficient credit for a particular content file selected (e.g., a TV show or music video), at least part of the content file can be modified in order to reduce the size of the content file to at least the size of the user's available credit.

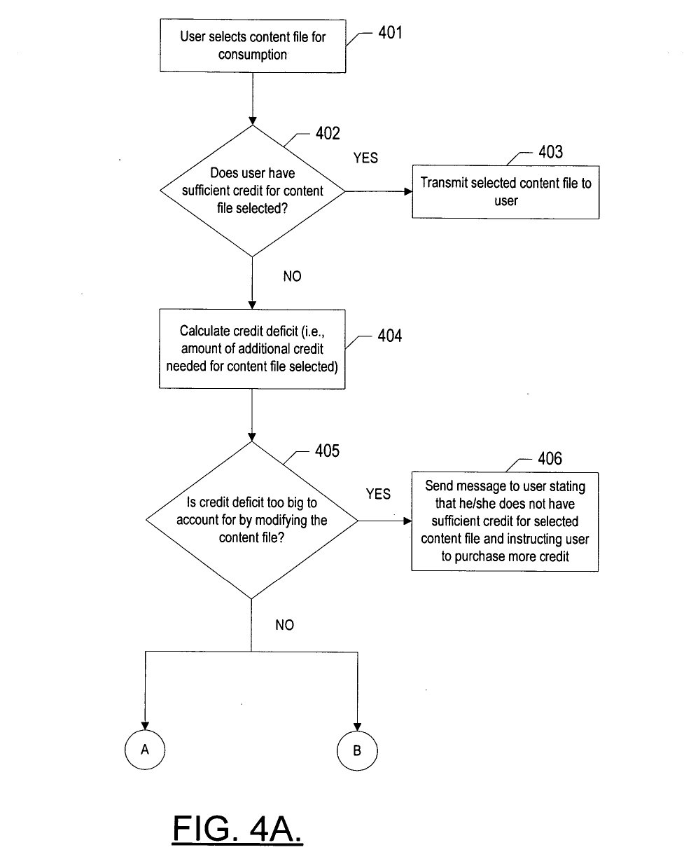

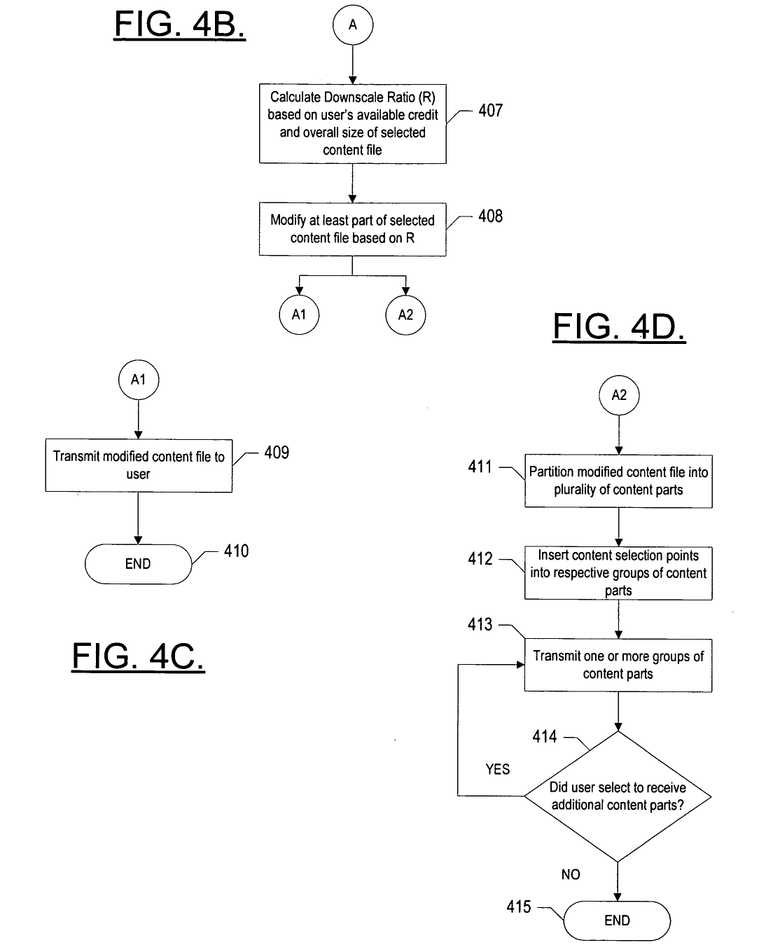

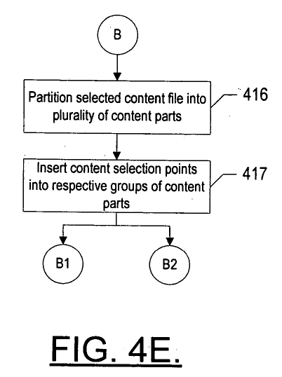

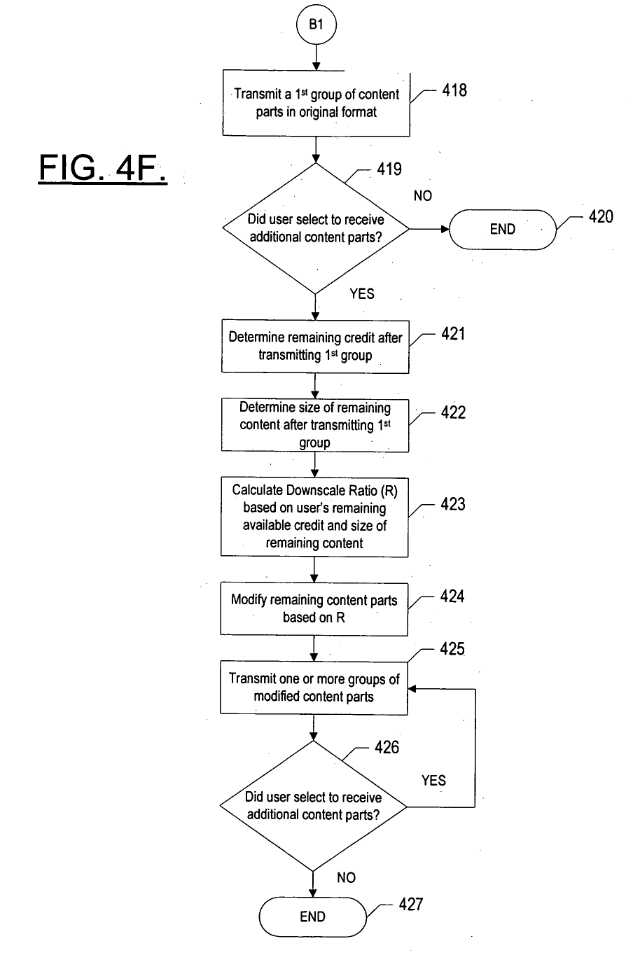

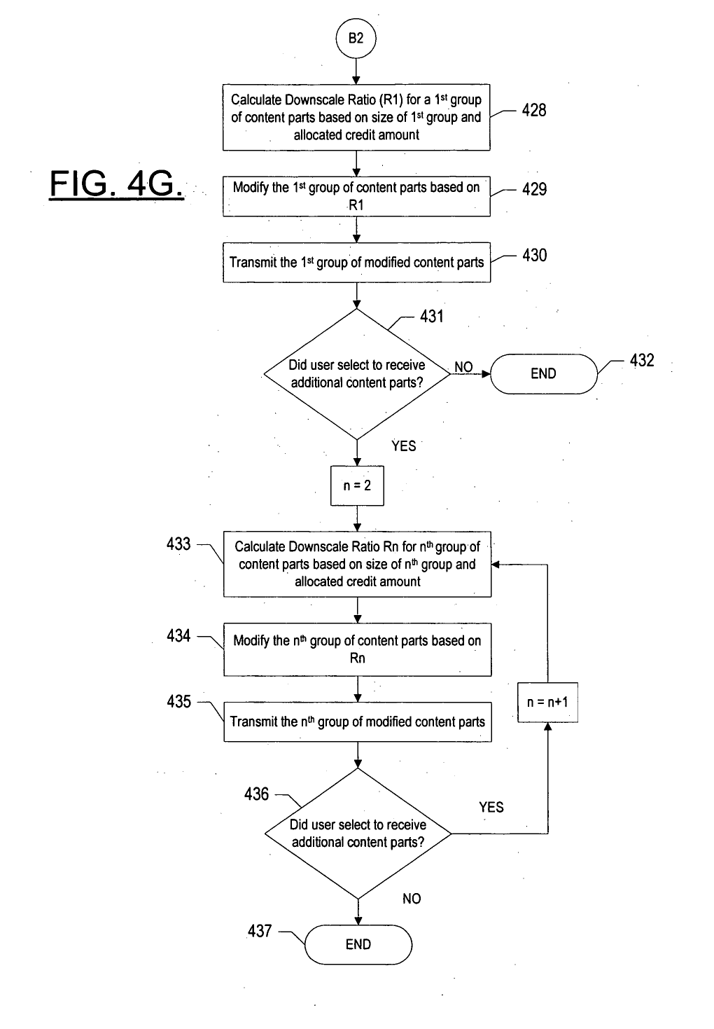

FIGS. 4A-4G are flow charts illustrating the method of providing one or more content files to a mobile terminal according to various exemplary embodiments of the present invention. As shown in FIG. 4A, the process begins at Step 401 where a user selects a content file for consumption. In one embodiment, this may be done through a media charger client operating on the mobile terminal that sends a request for a particular content file to the media charger server 26. The media charger server may, in one embodiment, comprise two logical parts, a content system that acts as a content file storage and a management system that interacts with the media charger client to, for example, provide content selection information and instructions for consuming and/or removing content files.

Upon receipt of the request for a content file, the media charger server 26, or any other network entity capable of functioning according to embodiments of the present invention, will first determine whether the user has sufficient credit for the content file selected (Step 402). In one embodiment, this involves determining the size of the content file and of the user's credit balance and then determining whether the size of the content file exceeds that of the user's credit balance. In one exemplary embodiment, the content file may be stored directly on the media charger server 26. They media charger server 26 may further store the user's account information, including the user's credit balance. In exemplary embodiments where both are stored on the media charger server 26, there would be no need for the media charger server 26 to access other network entities when making the determinations involved in Step 402. Alternatively, the content file may be stored on the content provider's server 22, and/or the user's account information may be stored on the billing system 24. In either of these exemplary embodiments, the media charger server 26 would be required to access either or both of the content provider's server 22 and the billing system 24 in order to determine whether the user has sufficient credit for the content file selected.

Where it is determined that the user does have sufficient credit for the content file selected, the content file selected is transmitted to the mobile terminal in Step 403. Alternatively, where it is determined that the user does not have sufficient credit, in one exemplary embodiment, a credit deficit is then calculated (Step 404). The credit deficit is the amount of additional credit that would be required for the content file selected. For example, where the content file selected is 10 Megabytes of data, and the user has available credit for only 8 Megabytes, the credit deficit is 2 Megabytes. Based on the calculation of Step 404, in one exemplary embodiment, in Step 405 it is determined whether the credit deficit is too big to account for by modifying the content file selected. In other words, does the user have so little credit that it would be impossible, or at least undesirable, to attempt to modify the content file to fit within the user's available credit? The determination of whether the credit deficit is too big may be based upon various factors. For example, a predetermined deficit may be defined so that if the actual credit deficit exceeds the predetermined deficit, the credit deficit is considered too big. Alternatively, a predetermined percentage may be defined so that if the percentage of the content file that is represented by the credit deficit (20% in the above example) exceeds the predetermined percentage, the credit deficit is considered too big. Where the credit deficit is determined to be too big, in Step 406 a message may be sent to the user indicating that he or she does not have sufficient credit for the content file selected and instructing the user to purchase more credit if he or she wants to continue receiving additional content files.

Where it is determined in Step 405 that the credit deficit is not too big to account for through modification of the content file or in embodiments that do not initially determine whether or not the credit deficit is too big, the method may proceed in one of at least two ways. FIGS. 4B-4D illustrate one way in which the method may proceed according to exemplary embodiments, wherein at least part of the content file is immediately modified. Alternatively, FIGS. 4E-4G illustrate another way in which the method may proceed, wherein the content file is first partitioned into a plurality of content parts prior to being modified. The first of these two paths (i.e., immediate modification) will be discussed first.

The first step of FIG. 4B, Step 407, is to calculate a downscale ratio (R) equal to the ratio of the user's available credit to the overall size of the selected content file. This downscale ratio can thereafter be used when modifying at least part of the content file (Step 408). In one exemplary embodiment, modifying the content file involves downscaling, or reducing the size or quality of, at least part of the content file. This can be done in a number of different ways. For example, the encryption of the content file can be made tighter, the audio quality or the frame rate of the content file may be decreased, the encoding or the resolution of the content file may be changed, or any of the preceding methods may be preformed in combination with one another. Which method is used to modify the content file may depend on the type of the content file and the extent to which it must be modified.

As an example, consider the scenario described above wherein the content file selected comprises 10 Megabytes of data, while the user's available credit is only for 8 Megabytes. The downscale ratio (R) in this scenario would be 0.8 (8/10). The overall size of the content file selected must therefore be downscaled, or reduced, by a factor of 0.8. In order to accomplish this, any combination of the above described methods may be used.

Once at least part of the content file has been modified, the method may again follow one of at least two paths illustrated in FIGS. 4C and 4D, respectively. In the first scenario, shown in FIG. 4C, the next step of exemplary embodiments is to transmit the entire modified content file to the user's mobile terminal (Step 409). The process then ends at Step 410, since the user now has the entire content file selected and has stayed within his or her credit balance.

Alternatively, as shown in Step 411 of FIG. 4D, the modified content file may first be partitioned into a plurality of content parts. In one embodiment, the content file may be partitioned based on where the content file would naturally be divided, for example in between scenes of a movie or TV show. Alternatively, a service provider may arbitrarily decide where to divide the content file into content parts. In Step 412 a content selection point is then inserted into at least one group of content parts, wherein each group contains any number of content parts, and in Step 413 one or more groups of content parts are transmitted to the mobile terminal.

The content selection points provide a user with the opportunity to preview a portion of a content file selected prior to deciding whether to either continue receiving content parts of the content file selected or stop receiving content parts. In general, this is beneficial because it allows the user to preview a portion of a content file selected before committing to purchase the entire content file. As an example, where a user selects to receive a particular TV show, according to exemplary embodiments of the present invention, the TV show may be partitioned into a plurality of content parts (e.g., one part corresponding to each scene of the TV show). The content parts may then be grouped into one or more groups, each including one or more content parts. Each group, for example, may include all of the scenes of the TV show that take place in between commercial breaks. A content selection point may then be inserted into at least one of the groups of content parts. One or more groups of content parts may then be transmitted to the user for review. If at least one of the groups transmitted includes a content selection point, the user will have the opportunity to view the content parts of the groups transmitted (e.g., the first one or more scenes of the show) and decide whether it is worth purchasing the entire content file, or show. Although described above with the content selection points being transmitted along with the content parts, the content selection points may alternatively be transmitted without the remainder of the respective content parts to permit the user to view the content selection points and make a decision as to purchasing the content file without ever transmitting the remainder of the content parts.

If, after reviewing the group of content parts containing the content selection point, the user selects to receive additional content parts (the determination is made in Step 414), the process returns to Step 413 where one or more groups of content parts are again transmitted to the mobile terminal. If however, the user does not select to receive additional content parts, the process ends at Step 415. Where the latest group of content parts sent to the mobile terminal is the last group, the group will not contain a content selection point, and the process will similarly end (Step 415), since the user would not have been given the opportunity to select to receive additional content parts. The user's credit will have been used only on the content parts that have been downloaded.

Returning now to FIG. 4A, the second path that may follow after it is determined in Step 405 that the credit deficit is not too big to account for with modification, in exemplary embodiments involves partitioning the content file into a plurality of content parts prior to modification. This path is illustrated in FIGS. 4E-4G and will now be discussed. The first step of FIG. 4E, Step 416, is to partition the selected content file into a plurality of content parts. In Step 417, content selection points are then inserted into at least one group of content parts, see discussion above with respect to FIG. 4D. By partitioning the content file prior to modification, respective groups of content parts may be modified to varying degrees, i.e., based on different downscale ratios. After the content file has been partitioned and one or more content selection points have been inserted, the process may again follow one of at least two paths illustrated by FIGS. 4F and 4G, respectively. Additionally, features of the methods described in FIGS. 4F and 4G may be combined.

In general, FIG. 4F illustrates an exemplary embodiment wherein a first portion of the content file is transmitted without modification, while a second portion is modified based on the credit remaining after the first portion was transmitted and the size of the second portion. This embodiment enables the user to receive at least some portion of the content file having its original quality. In contrast, FIG. 4G illustrates an exemplary embodiment wherein multiple groups of content parts are modified, each using a different downscale ratio, wherein portions of the user's credit balance are allocated to respective groups of content parts. As will be understood by those of skill in the art, any number of scenarios may be embodied in the present invention wherein the content file is divided into any number of portions and each portion is modified (or not modified) in any number of ways and to varying degrees.

Referring now to FIG. 4F, following the insertion of the content selection points (Step 417 of FIG. 4E), a first group of content parts may be transmitted in its original format (Step 418). The size of this group may depend upon how large the user's credit deficit is. For instance, where the credit deficit is small, i.e., the user is just shy the amount of credit needed to receive the content file selected, a larger portion of the content file may be transmitted in its original format and quality. In contrast, where the credit deficit is large, the user may only be able to receive a small portion of the content file without modification.

In step 419, it is determined whether the user has selected to receive additional content parts. As described above, the content selection point previously inserted (Step 417) into the group of content parts transmitted in Step 418 enable the user to view a portion of the content file and then designate whether he or she wishes to receive additional portions of the content file. If the user has not selected to receive additional content parts, the process ends at Step 420. Where the user has selected to receive additional content parts, the process proceeds to Step 421 where the credit balance remaining after the transmission of the first group of content parts is determined. For example, continuing with the example discussed above, where the user originally had credit for 8 Megabytes of data, and 2 Megabytes of data were transmitted in Step 418, the credit remaining is for 6 Megabytes of data.

In Step 422 the size of the content remaining after the first group is transmitted is determined. In the example above, where the content file selected was 10 Megabytes, and 2 Megabytes were transmitted in the first group, the size of the content remaining after the first group is transmitted is 8 Megabytes.

Next, a downscale ratio (R) equal to the ratio of the remaining available credit to the size of the remaining content is calculated (Step 423). In the above example, the downscale ratio would be 0.75 (credit remaining=6/size of content remaining=8). The calculated downscale ratio is then used, in Step 424, to modify the remaining content parts using any of the methods discussed above. In Step 425, one or more groups of modified content parts are transmitted to the mobile terminal. It is then again determined whether the user has selected to receive additional groups of content parts (Step 426). The process ends where the user has not so selected (Step 427), which would be the case where the latest group transmitted is the last group and, therefore, does not include a content selection point. Alternatively, where the user does select to receive additional content parts, the process loops back to Step 425 where one or more groups of content parts are again transmitted.

Referring now to FIG. 4G where the second path following the step of inserting content selection points (Step 417) is illustrated, the first step, Step 428, is to calculate a downscale ratio (R1) for a first group of content parts based on the size of the first group and an allocated credit amount. In exemplary embodiments, the first group of content parts is then modified, in Step 429, based on the calculated downscale ratio (R1) and transmitted, in Step 430, to the mobile terminal. In Step 431 it is determined, using the content selection points previously inserted, whether the user desires to receive additional content parts. If the user does not so desire, the process ends (Step 432). Alternatively, where the user does desire to receive additional content parts, the process continues to Step 433 where a second downscale ratio (R2) is calculated based on the size of a second group of content parts and the size of the credit amount allocated to this second group. This second downscale ratio (R2) is then used to modify the second group (Step 434), and the modified second group is transmitted to the mobile terminal (Step 435). Steps 433-435 are repeated each time the user selects to receive additional content parts (Step 436). Otherwise, the process ends (Step 437). While the downscale ratios may be calculated as described above, the user can select smaller downscale ratios for one or more groups of content parts if the user is willing for the one or more groups of content parts to be modified to a greater extent, thereby allowing other groups of content parts to be modified to a lesser extent, if at all.

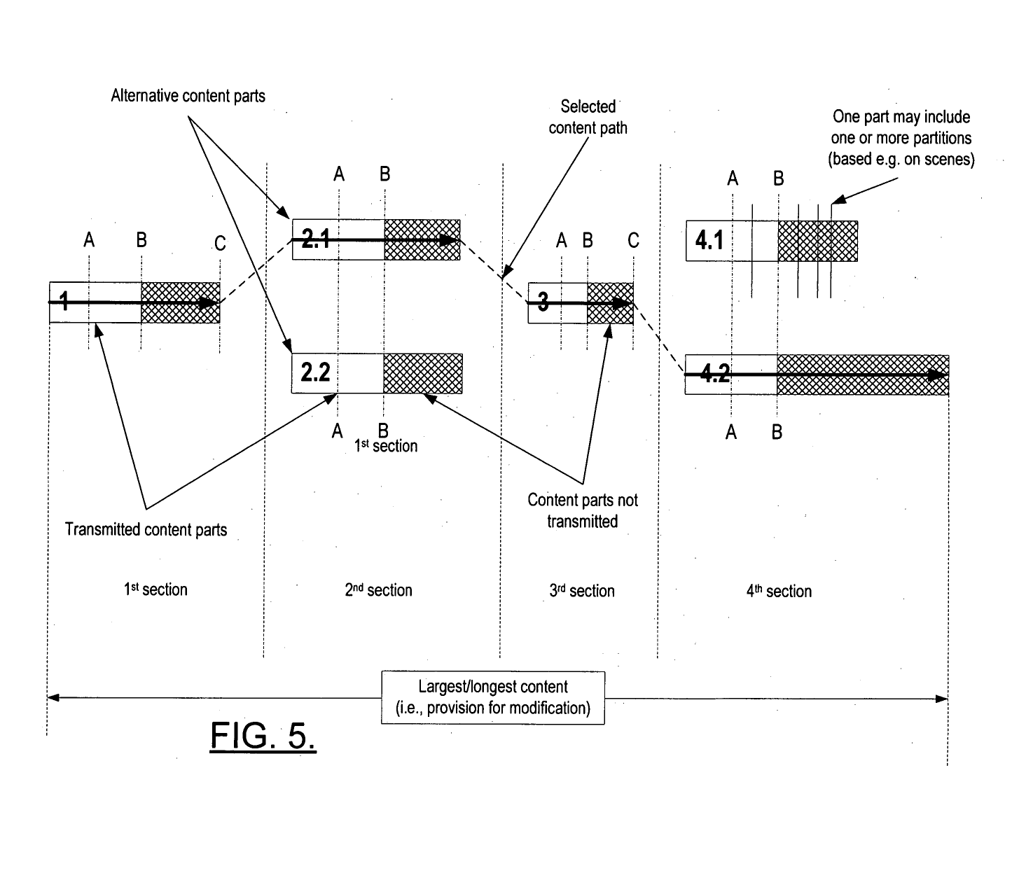

FIG. 5 illustrates an example of another scenario which may occur when providing content files to a mobile terminal. In this scenario, the selected content file has one or more alternative content parts. This may occur, for example, where a movie has alternate endings or alternate scenes (e.g., one in its original format and one that has been edited for viewing by a younger audience, or one that is a so-called “director's-cut” version). The example content file shown in FIG. 5 may be divided into four sections, wherein the second and fourth sections each include two alternative content parts. Each section includes content selection points A, B and C, discussed above, which enable the user to view a portion of the various content parts, including the alternative content parts, before deciding to download or otherwise receive additional content parts of the content file.

A potential problem arises in this scenario where alternative content parts are of a different size (as shown in FIG. 5 by the alternative content parts in the fourth section—i.e., 4.1 and 4.2). The potential problem is that the overall size of the content file ultimately received by the user is not known prior to transmission of the content file, for purposes of calculating a downscale ratio. If all of the content parts are taken into consideration, including each alternative content part (i.e., content parts 1, 2.1, 2.2, 3, 4.1 and 4.2), then the extent to which the content file would need to be downscaled could be quite great.

Exemplary embodiments of the present invention solve this potential problem in several ways. The first is to initially use the largest possible content file when calculating the downscale ratio. In other words, where there are alternative content parts of varying size, select the largest of the alternative parts when determining the size of the overall content file (e.g., use 4.2 rather than 4.1). Using this method, the user is guaranteed to have sufficient credit to receive the entire content file selected, yet the quality of the content file will not be unnecessarily jeopardized.

Another technique of exemplary embodiments of the present invention to deal with this problem is to recalculate the downscale ratio at least after each portion of the content file that includes an alternative content part has been transmitted (e.g., after the second portion of the content file in FIG. 5 has been transmitted). This way, the remaining content may be dynamically modified according to a selected path (i.e., based on the amount of remaining credit and content parts).

Another aspect of exemplary embodiments of the present invention shown in FIG. 5 is that a first portion of each content part may be simultaneously transmitted. This is beneficial, for example, where there are alternative content parts and it is not possible to download all or both of the alternative content parts in a time slot that is available during the consumption of the previous content part. Therefore, it might only be possible to download first sections of the two or more alternative content parts. Alternatively, portions of each content part may be transmitted consecutively.

In other exemplary embodiments of the invention, the user's credit information may be stored in the user terminal. The credit information may then be sent together with a request for a content download to a service provider/server. After the content has been consumed, the service provider/server may then update the user's credit information in the user terminal. Alternatively, after requesting the content from the service provider/server, the user terminal may receive information on the amount of credit needed for the content download requested. The user terminal may then make the comparison, define a downscale ratio and transmit the results back to the service provider/server. The service provider/server can then use this information for modifying and transmitting the requested content to the user terminal.

In further exemplary embodiments, if the user device has two displays, for example one smaller display on the front cover of the device and a larger display on the inside of the cover (i.e., a clamshell form factor), or one black and white display and one color display, the requested content may be divided for the two displays of the device. One or more of the displays may further be external to the user device, yet available for use by the user. In these exemplary embodiments, the content/service provider/server may modify one or more parts of the content for one display and another one or more parts of the content for the other display. For the modification and delivery of such content, therefore, the content/service provider/server needs to know what kind of device the user has (i.e., how many displays are available and what are the capabilities of those displays). The above described method is useful, for example, when the first part of the content is modified for a small or black and white display, and after the user decides to receive additional content parts, the new parts of the content are modified for a large or color display. Additionally, if the content/service provider/server transmits messages to the user terminal, the messages may have two parts: (1) an alert message for a small or black and white display for alerting the user of various things; and (2) the actual content modified for the large or color display.

In yet further exemplary embodiments, a media charger server may provide specific content files and messages only in a specific broadcasting cell. These specific content files and messages may be, for example, a personalized video greeting tied to a specific location and stored in the media charger server from a first user to a second user, a communication cell specific announcement for alert, a customized content file tied to a specific location from a content service provider to a user, etc.

This service may also cover a list of available cells that every cellular-based terminal (e.g., GSM, GPRS, WCDMA, CDMA, WLAN, Bluetooth) gets. This is basically the base feature of every cell network. This means that the terminal calculates what are the near cells in the hood and receives the signal strength at all times. Based on the signals, the terminal can automatically choose which cell to use. Further, exemplary embodiments of this invention can use the data collected by the terminal by creating so-called “second tier” cells to a so-called dynamic list. In other words, if the terminal hasn't actually visited in the cell, but has passed near it and has been able to measure the strength of the signal, that cell is added to the dynamic list. Now, media charger services or servers available in those “second tier” cells are polled (i.e., a request for service is sent) based on the dynamic list. This enables the user terminal to cover a wider service area of localized content files and messages accessing only the automatically selected cells.

Conclusion:

As will be appreciated by one skilled in the art, the embodiments of the present invention described above may be embodied as a system, method, mobile terminal device or other apparatus, or computer program product. Accordingly, the present invention may take the form of an entirely hardware embodiment, an entirely software embodiment, or an embodiment combining software and hardware aspects. Furthermore, embodiments of the present invention may take the form of a computer program product on a computer-readable storage medium having computer-readable program instructions (e.g., computer software) embodied in the storage medium. More particularly, the present invention may take the form of web-implemented computer software. Any suitable computer-readable storage medium may be utilized including hard disks, CD-ROMs, optical storage devices, or magnetic storage devices.

The present invention is described above with reference to block diagrams and flowchart illustrations of methods, apparatuses (i.e., systems) and computer program products according to an embodiment of the invention. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks, although other means for implementing the functions including various combinations of hardware, firmware and software as described herein may also be employed.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of providing one or more content files to a user terminal, said method comprising:
receiving a request for a content file from a user associated with the user terminal
determining whether a credit balance associated with the user is sufficient for the content file requested;
modifying at least part of the content file where it is determined that the credit balance is not sufficient; and
transmitting at least part of the content file to the user terminal.

2. The method of claim 1, wherein transmitting at least part of the content file to the user terminal comprises transmitting a modified part of the content file.

3. The method of claim 1, wherein transmitting at least part of the content file to the user terminal comprises transmitting an unmodified part of the content file.

4. The method of claim 1, wherein transmitting at least part of the content file to the user terminal comprises transmitting a modified part of the content file and an unmodified part of the content file.

5. The method of claim 1, wherein the user terminal comprises a mobile terminal.

6. The method of claim 1, wherein determining whether the credit balance is sufficient for the content file requested comprises:
determining a size of the content file;
determining a size of the credit balance; and
comparing the size of the content file to the size of the credit balance with the credit balance being determined to be insufficient where the size of the content file exceeds the size of the credit balance.

7. The method of claim 1 further comprising, upon a determination that the credit balance is insufficient, determining whether the content file can be sufficiently modified so that the size of a modified content file is equal to or less than the size of the credit balance.

8. The method of claim 7 further comprising, upon a determination that the content file cannot be sufficiently modified, transmitting a message to the user indicating that the user has an insufficient credit balance for the content file requested.

9. The method of claim 1, wherein modifying at least part of the content file comprises:
calculating a downscale ratio based at least in part on a size of the content file and a size of the credit balance; and
reducing the size of at least part of the content file based on the downscale ratio calculated.

10. The method of claim 9, wherein reducing the size of at least part of the content file comprises one or more of tightening an encryption of at least part of the content file, decreasing an audio quality of at least part of the content file, decreasing a frame rate of at least part of the content file, changing an encoding of at least part of the content file and decreasing a resolution of at least part of the content file.

11. The method of claim 1, wherein transmitting at least part of the content file to the user terminal comprises consecutively transmitting one or more groups of content parts of the content file, wherein each group comprises one or more of the content parts.

12. The method of claim 1, wherein modifying at least part of the content file comprises modifying at least one of one or more groups of content parts of the content file.

13. The method of claim 12, wherein modifying at least one of the groups of content parts comprises:
allocating a portion of the credit balance to at least one group of content parts;
calculating a downscale ratio for the group of content parts based at least in part on a size of the group of content parts and a size of the portion of the credit balance allocated to the group of content parts; and
reducing the size of the group of content parts based on the downscale ratio calculated.

14. The method of claim 1, further comprising:
partitioning the content file into a plurality of content parts.

15. The method of claim 14, wherein the content file is partitioned before at least part of the content file is modified.

16. The method of claim 14, wherein the content file is partitioned after at least part of the content file has been modified.

17. The method of claim 11 further comprising:
inserting a content selection point into at least one of the groups of content parts, wherein the content selection point allows the user to specify whether the user wishes to receive one or more additional groups of content parts;
determining, after sending a group of content parts including the content selection point and prior to transmitting an additional group of content parts, whether the user wishes to receive additional groups of content parts; and
ceasing to transmit additional groups of content parts where it is determined that the user does not wish to continue.

18. The method of claim 11, wherein one or more groups of content parts comprise two or more alternative content parts, such that a user can select an alternative content part from each group.

19. The method of claim 18, wherein each group of content parts comprising alternative content parts comprises a largest alternative content part, and wherein modifying at least part of the content file comprises:
calculating a downscale ratio based at least in part on a size of the content file and a size of the credit balance, wherein the size of the content file is based in part on the size of the largest alternative content part from among the alternative content parts of each group of content parts comprising alternative content parts; and
reducing the size of at least part of the content file based on the downscale ratio calculated.

20. The method of claim 19, wherein transmitting at least part of the content file comprises transmitting a group of content parts including an alternative content part selected by the user, such that one or more groups of content parts remain to be transmitted and a portion of the credit balance is unused, and wherein the method further comprises:
recalculating the downscale ratio based on a size of the one or more groups of content parts that remain to be transmitted and a size of the portion of the credit balance that is unused;
reducing the size of the one or more groups of content parts that remain based on the downscale ratio recalculated;
transmitting one or more additional groups of content parts; and
repeating the steps of recalculating, reducing and transmitting until no groups of content parts remain to be sent.

21. A server capable of providing one or more content files to a user terminal, said server comprising:
a processor; and
a memory module in communication with the processor that stores an application executable by the processor, wherein the application is capable, upon execution, of receiving a request for a content file from a user associated with the user terminal, the application further capable, upon execution, of determining whether a credit balance associated with the user is sufficient for the content file requested, the application further capable, upon execution, of modifying at least part of the content file where it is determined that the credit balance is not sufficient, and said application further capable, upon execution, of transmitting at least part of the content file to the user terminal.

22. The server of claim 21, wherein transmitting at least part of the content file to the user terminal comprises transmitting a modified part of the content file.

23. The server of claim 21, wherein transmitting at least part of the content file to the user terminal comprises transmitting an unmodified part of the content file.

24. The server of claim 21, wherein transmitting at least part of the content file to the user terminal comprises transmitting a modified part of the content file and an unmodified part of the content file.

25. The server of claim 21, wherein the user terminal comprises a mobile terminal.

26. The server of claim 21, wherein the application is capable of determining whether the credit balance is sufficient for the content file requested by:
determining a size of the content file;
determining a size of the credit balance;
comparing the size of the content file to the size of the credit balance with the credit balance being determined to be insufficient where the size of the content file exceeds the size of the credit balance.

27. The server of claim 21, wherein the application is further capable, upon execution and upon a determination that the credit balance is insufficient, of determining whether the content file requested can be sufficiently modified so that the size of a modified content file is equal to or less than the size of the credit balance.

28. The server of claim 27, wherein the application is further capable, upon execution and upon a determination that the content file requested cannot be sufficiently modified, of transmitting a message to the user indicating that the user has an insufficient credit balance for the content file requested.

29. The server of claim 21, wherein the application is capable of modifying at least part of the content file by:
calculating a downscale ratio based at least in part on a size of the content file and a size of the credit balance; and
reducing the size of at least part of the content file based on the downscale ratio calculated.

30. The server of claim 29, wherein the application is capable of reducing the size of at least part of the content file by one or more of tightening an encryption of at least part of the content file, decreasing an audio quality of at least part of the content file, decreasing a frame rate of at least part of the content file, changing an encoding of at least part of the content file and decreasing a resolution of at least part of the content file.

31. The server of claim 21, wherein transmitting at least part of the content file to the user terminal comprises consecutively transmitting one or more groups of content parts of the content file, wherein each group comprises one or more of the content parts.

32. The server of claim 21, wherein the application is capable of modifying at least part of the content file by modifying at least one of one or more groups of content parts of the content file.

33. The server of claim 32, wherein the application is capable of modifying at least one of the groups of content parts by:
allocating a portion of the credit balance to at least one group of content parts;
calculating a downscale ratio for the group of content parts based at least in part on a size of the group of content parts and a size of the portion of the credit balance allocated to the group of content parts; and
reducing the size of the group of content parts based on the downscale ratio calculated.

34. The server of claim 21, wherein the application is further capable, upon execution, of partitioning the content file into a plurality of content parts.

35. The server of claim 34, wherein the content file is partitioned before at least part of the content file is modified.

36. The server of claim 34, wherein the content file is partitioned after at least part of the content file has been modified.

37. The server of claim 31, wherein the application is further capable, upon execution, of inserting a content selection point into at least one of the groups of content parts, wherein the content selection point allows the user to specify whether the user wishes to receive one or more additional groups of content parts, said application further capable, upon execution, of determining, after sending a group of content parts including the content selection point and prior to transmitting an additional group of content parts, whether the user wishes to receive additional groups of content parts, and said application further capable, upon execution, of ceasing to transmit additional groups of content parts where it is determined that the user does not wish to continue.

38. The server of claim 31, wherein one or more groups of content parts comprise two or more alternative content parts, such that a user can select an alternative content part from each group.

39. The server of claim 38, wherein each group of content parts comprising alternative content parts comprises a largest alternative content part, and wherein modifying at least part of the content file comprises:
calculating a downscale ratio based at least in part on a size of the content file and a size of the credit balance, wherein the size of the content file is based in part on the size of the largest alternative content part from among the alternative content parts of each group of content parts comprising alternative content parts; and
reducing the size of at least part of the content file based on the downscale ratio calculated.

40. The server of claim 39, wherein transmitting at least part of the content file comprises transmitting a group of content parts including an alternative content part selected by the user, such that one or more groups of content parts remain to be transmitted and a portion of the credit balance is unused, and wherein the application is further capable, upon execution, of:
recalculating the downscale ratio based on a size of the one or more groups of content parts that remain to be transmitted and a size of the portion of the credit balance that is unused;
reducing the size of the one or more groups of content parts that remain based on the downscale ratio recalculated;
transmitting one or more additional groups of content parts; and
repeating the steps of recalculating, reducing and transmitting until no groups of content parts remain to be sent.

41. A system for providing a user terminal with one or more content files, said system comprising:
a user terminal capable of transmitting a request by a user for a content file; and
a server in communication with the user terminal for receiving the request for a content file, said server capable of determining whether a credit balance associated with the user is sufficient for the content file requested, said server further capable of modifying at least part of the content file where it is determined that the credit balance is not sufficient, and said server further capable of transmitting at least part of the content file to the user terminal.

42. The system of claim 41, wherein transmitting at least part of the content file to the user terminal comprises transmitting a modified part of the content file.

43. The system of claim 41, wherein transmitting at least part of the content file to the user terminal comprises transmitting an unmodified part of the content file.

44. The system of claim 41, wherein transmitting at least part of the content file to the user terminal comprises transmitting a modified part of the content file and an unmodified part of the content file.

45. The system of claim 41, wherein the user terminal comprises a mobile terminal.

46. The system of claim 41 further comprising:
a content server accessible by the server, wherein the server is further capable of retrieving the content file requested from the content server.

47. The system of claim 41 further comprising:
a database accessible by the server, said database storing one or more credit balances associated with one or more respective users, wherein accessing a credit balance associated with the user comprises accessing the database in order to retrieve the credit balance.

48. The system of claim 41, wherein the server is further capable, upon a determination that the credit balance is insufficient, of determining whether the content file requested can be sufficiently modified so that a modified content file is the same size or smaller than the credit balance.

49. The system of claim 48, wherein the server is further capable, upon a determination that the content file requested cannot be sufficiently modified, of transmitting a message to the user indicating that the user has an insufficient credit balance for the content file requested.

50. The system of claim 41 wherein the server is capable of modifying at least part of the content file by:
calculating a downscale ratio based at least in part on a size of the content file and a size of the credit balance; and
reducing the size of at least part of the content file based on the downscale ratio calculated.

51. The system of claim 50, wherein the server is capable of reducing the size of at least part of the content file by one or more of tightening an encryption of at least part of the content file, decreasing an audio quality of at least part of the content file, decreasing a frame rate of at least part of the content file, changing an encoding of at least part of the content file and decreasing a resolution of at least part of the content file.

52. The system of claim 41, wherein transmitting at least part of the content file to the user terminal comprises consecutively transmitting one or more groups of content parts of the content file, wherein each group comprises one or more of the content parts.

53. The system of claim 41, wherein the server is capable of modifying at least part of the content file by modifying at least one of one or more groups of content parts of the content file.

54. The system of claim 53, wherein the server is capable of modifying at least one of the groups of content parts by:
allocating a portion of the credit balance to at least one group of content parts;
calculating a downscale ratio for the group of content parts based at least in part on a size of the group of content parts and a size of the portion of the credit balance allocated to the group of content parts; and
reducing the size of the group of content parts based on the downscale ratio calculated.

55. The system of claim 41, wherein the server is further capable of partitioning the content file into a plurality of content parts.

56. The system of claim 55, wherein the content file is partitioned before at least part of the content file is modified.

57. The system of claim 55, wherein the content file is partitioned after at least part of the content file has been modified.

58. The system of claim 52, wherein the server is further capable of inserting a content selection point into at least one of the groups of content parts, wherein the content selection point allows the user to specify whether the user wishes to receive one or more additional groups of content parts, said server further capable of determining, after sending a group of content parts including the content selection point and prior to transmitting an additional group of content parts, whether the user wishes to receive additional groups of content parts, and said server further capable of ceasing to transmit additional groups of content parts where it is determined that the user does not wish to continue.

59. A computer program product for providing a content file to a user terminal, wherein the computer program product comprises at least one computer-readable storage medium having computer-readable program code portions stored therein, the computer-readable program code portions comprising:
a first executable portion for receiving a request for a content file from a user associated with the user terminal
a second executable portion for determining whether a credit balance associated with the user is sufficient for the content file requested;
a third executable portion for modifying at least part of the content file where it is determined that the credit balance is not sufficient; and
a fourth executable portion for transmitting at least part of the content file to the user terminal.

60. A user terminal capable of receiving one or more content files, said user terminal comprising:
means for transmitting a request for a content file comprising one or more parts;
means for receiving, in response to the request, at least one part of the content file requested, said part including a content selection point enabling a user associated with the user terminal to specify whether the user wishes to receive one or more additional parts of the content file requested;
means for presenting the content selection point to the user and enabling the user to specify whether the user wishes to receive one or more additional parts; and
means for transmitting a request for one or more additional parts of the content file requested in response to the user specifying that the user wishes to receive one or more additional parts.

61. The user terminal of claim 60 further comprising:
means for storing the one or more parts of the content file received.
